(19) United States
(12) Patent Application Publication
(10) Pub. No.: US 2012/0194639 A1
(43) Pub. Date: Aug. 2, 2012

(54) IMAGE-PROCESSING METHOD AND APPARATUS

(75) Inventors: Hye-Young Jun, Hwaseong-si (KR); Hyun-Kwon Chung, Seoul (KR); Dae-Jong Lee, Gyeonggi-do (KR)

(73) Assignee: SAMSUNG ELECTRONICS CO., LTD., Suwon-si (KR)

(21) Appl. No.: 13/304,751

(22) Filed: Nov. 28, 2011

Related U.S. Application Data
(63) Continuation of application No. PCT/KR2010/003296, filed on May 25, 2010.
(60) Provisional application No. 61/183,612, filed on Jun. 3, 2009.
(60) Provisional application No. 61/181,455, filed on May 27, 2009.

(30) Foreign Application Priority Data
May 12, 2010 (KR) 10-2010-0044500

(51) Int. Cl. H04N 13/00

(52) U.S. Cl. 348/42; 348/E13.001

(57) ABSTRACT

An image processing apparatus and method includes extracting video depth information indicating a depth of a 3D video image from a video stream. The image processing apparatus and method also includes adjusting a depth value of a graphic screen, to be synchronized with the 3D video image, using the video depth information.

### CROSS REFERENCE TO RELATED APPLICATIONS

This application is a continuation of International Application No. PCT/KR2010/003296, filed May 25, 2010, which claims the benefit under 35 U.S.C. §119(a) of Korean Patent Application No. 10-2010-0044500, filed May 12, 2010, and claims the benefit under 35 U.S.C. §119(e) of U.S. Provisional Patent Application No. 61/183,612, filed Jun. 3, 2009, and U.S. Provisional Patent Application No. 61/181,455, filed May 27, 2009. The subject matters of the earlier filed applications are hereby incorporated by reference.

### BACKGROUND

1. Field

The following description relates to a method and apparatus to process an image, and more particularly, to a method and apparatus to process an image to adjust a depth value of a graphic screen that is to be reproduced with a 3-dimensional (3D) image using a depth value of a 3D video image.

2. Description of the Related Art

Technology to reproduce a video image in a 3-dimensional (3D) image has become widely available with the development of digital technology.

The 3D video image may be displayed with a graphic element, such as a menu or a subtitle additionally provided with a video image. The graphic element reproduced with the 3D video image may be reproduced in 2-dimension (2D) or 3D.

FIGS. 1A, 1B and 1C are diagrams illustrating depth values of a video image and a graphic element in the occasion that the video image and the graphic element are reproduced in 3D. The video image may include one or more objects. In FIGS. 1A, 1B, and 1C, an object is included in the video image.

As illustrated in FIG. 1A, a protrusion from a screen 100 is referred to as a depth value. A depth value 110 of the object, in this instance, a smiley face, included in the video image is greater than a depth value 120 of the graphic element, in this instance, a menu. Thus, the object appears to protrude more from the screen 100 than the graphic element. In this case, a viewer looking at the screen 100 recognizes that the menu is disposed more inward than the object included in the video image. The graphic element is disposed more inward than the object included in the video image, so as to partly hide the object. In this case, the viewer recognizes that the object and the graphic element are reproduced distortedly.

Referring to FIGS. 1B and 1C, the depth value 120 of the graphic element between both figures remains unchanged, and the depth value 110 of the object included in the video image reproduced with the graphic element between both figures varies. In general, the depth value 120 of the graphic element has a fixed value or varies with respect to a specific time. Meanwhile, the depth value 110 of the object included in the video image varies.

In FIGS. 1B and 1C, it is assumed that the depth value 110 of the object included in the video image of a left frame and a right frame differs, whereas the depth value 120 of the graphic element of the left frame and the right frame is the same. A difference in the depth value 110 of the object included in the video image and the depth value 120 of the graphic element in a left frame (FIG. 1B) is smaller than a difference in the depth value 110 of the object and the depth value 120 of the graphic element in a right frame (FIG. 1C). Where the left frame and the right frame are sequentially reproduced, variations occur between the depth value 110 of the object included in the video image and the depth value 120 of the graphic element of the left frame and the right frame. As a result, the viewer may feel disoriented due to the differences between the depth value 110 of the object included in the video image and the depth value 120 of the graphic element.

### SUMMARY

In one general aspect, a method and apparatus are provided configured to process an image. The method and apparatus adjust a depth value of a graphic screen using a depth value of a video image to allow a viewer to recognize natural reproduction of a video image and a graphic screen.

In another aspect, there is also provided a method and apparatus configured to process an image. The method and apparatus reproduces a video image and a graphic screen together by providing a 3-dimensional (3D) effect in which the video image is disposed more inward than the graphic screen.

In one aspect, there is provided an image processing method. The method may include extracting video depth information indicating a depth of a 3D video image from a video stream. The method may also include adjusting a depth value of a graphic screen, to be synchronized with the 3D video image, using the video depth information.

The video depth information may include depth values of the 3D video image or pixel movement distance values corresponding to the depth values of the 3D video image. The depth values increase from an inside of a screen to an outside of a screen on which a video image is output. The adjusting of the depth value of the graphic screen may include adjusting the depth value of the graphic screen to be equal to or greater than the depth values of the 3D video image.

Where the 3D video image includes a plurality of objects, and the video depth information includes depth information of two or more of the plurality of objects, the adjusting of the depth value of the graphic screen includes adjusting the depth value of the graphic screen to be equal to or greater than a depth value of an object having the greatest depth value among the two or more objects.

The video stream may include a plurality of access units that are decoding units. The extracting of the video depth information may include extracting the video depth information from each of the plurality of access units.

The adjusting of the depth value of the graphic screen may include adjusting the depth value of the graphic screen, to be synchronized with the plurality of access units from which the video depth information is extracted, using the extracted video depth information.

The extracting of the video depth information may include extracting the video depth information from user data supplemental enhancement information (SEI) messages of the plurality of access units.

The video stream may include one or more groups of pictures (GOPs) including a plurality of access units, which are decoding units. The extracting of the video depth information may include extracting the video depth information from one of the plurality of access units.

The extracting of the video depth information may include extracting the video depth information from user data SEI messages of one of the plurality of access units.

The video depth information may include a number of the depth values of the 3D video image or a number of the corresponding pixel movement distance values. Where the plurality of access units are divided into groups by the number included in the video depth information, the adjusting of the depth value of the graphic screen may include adjusting the depth value of the graphic screen, to be synchronized with the plurality of access units included in each group, using one of the depth values of the 3D video image included in the video depth information or one of the corresponding pixel movement distance values.

According to another aspect, there is provided an image processing apparatus including a video decoder configured to decode a video stream and generate a left eye image and a right eye image. The image processing apparatus may also include a graphic decoder configured to decode a graphic stream and generate a graphic screen. The image processing apparatus includes a video depth information extraction unit configured to extract video depth information indicating a depth of a 3D video image from the video stream. The image processing apparatus may also include a graphic screen depth value adjusting unit configured to adjust a depth value of the graphic screen, to be synchronized with the 3D video image, using the video depth information.

According to another aspect, there is provided a non-transitory computer readable recording medium having recorded thereon a program configured to execute an image processing method. The image processing method may include extracting video depth information indicating a depth of a 3D video image from a video stream. The image processing method may also include adjusting a depth value of a graphic screen, to be synchronized with the 3D video image, using the video depth information.

In one aspect, an image processing apparatus includes a video decoder configured to decode a video stream and generating a left eye image and a right eye image. The image processing apparatus also includes a graphic decoder configured to decode a graphic stream and generating a graphic screen. The apparatus also includes a video depth information extraction unit configured to extract video depth information from the video stream. The apparatus further includes a graphic screen depth value adjusting unit configured to adjust a depth value of the graphic screen to be synchronized with the 3D video image using the video depth information, and configured to generate a left eye graphic screen and a right eye graphic screen from the graphic screen. The image processing apparatus also includes an output unit configured to simultaneously reproduce the left eye image and the left eye graphic screen, and configured to simultaneously reproduce the right eye image and the right eye graphic screen, and configured to alternately output the left eye image and the right eye image including the graphic screen and reproduce the 3D video image.

In one general aspect, a depth value of a video image is used to adjust a depth value of a graphic screen and simultaneously reproduce the graphic screen having an adjusted depth value and the video image.

In another aspect, a video image and a graphic screen are simultaneously reproduced by providing a 3D effect in which the video image is disposed more inward than the graphic screen.

Other features and aspects may be apparent from the following detailed description, the drawings, and the claims.

### BRIEF DESCRIPTION OF THE DRAWINGS

The above and other features and advantages of the present invention will become more apparent by describing in detail exemplary embodiments thereof with reference to the attached drawings in which:

FIGS. 1A, 1B, and 1C are diagrams illustrating depth values of a video image and a graphic element reproduced 3-dimensionally (3D);

FIG. 2 is a block diagram illustrating an example of a video stream according;

FIG. 3 is a block diagram illustrating an example of a video stream;

FIG. 4 is a block diagram illustrating an example of a video stream;

FIGS. 5A and 5B are tables illustrating an example of a syntax presenting video depth information included in a supplemental enhancement information (SEI) message;

FIG. 6 is a block diagram illustrating an example of an image processing apparatus; and

FIG. 7 is a flowchart illustrating an example of an image processing method.

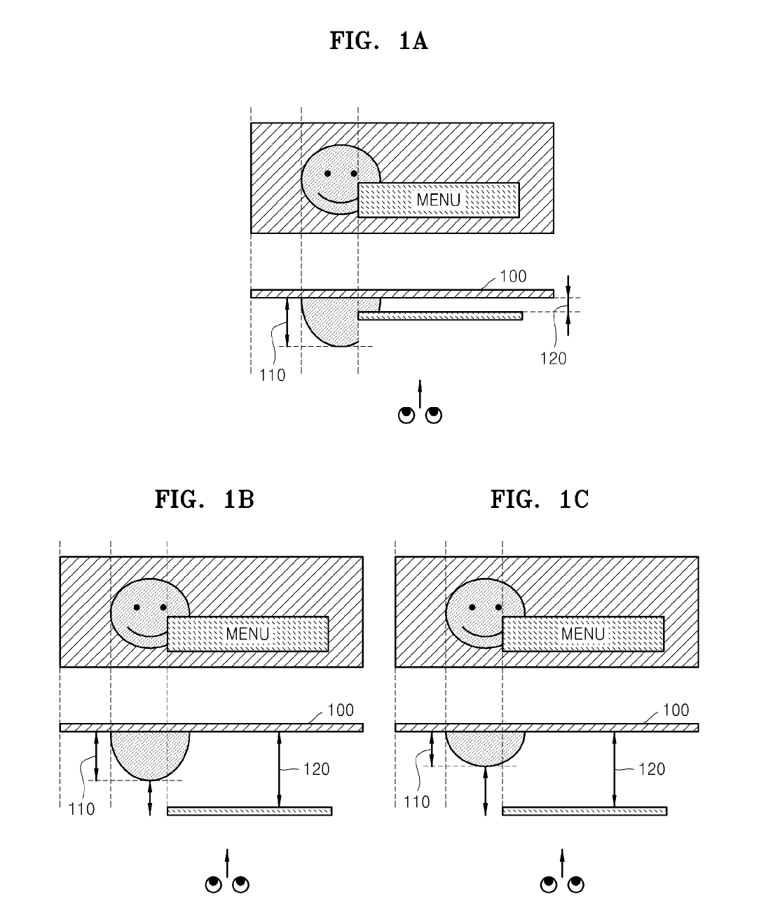

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

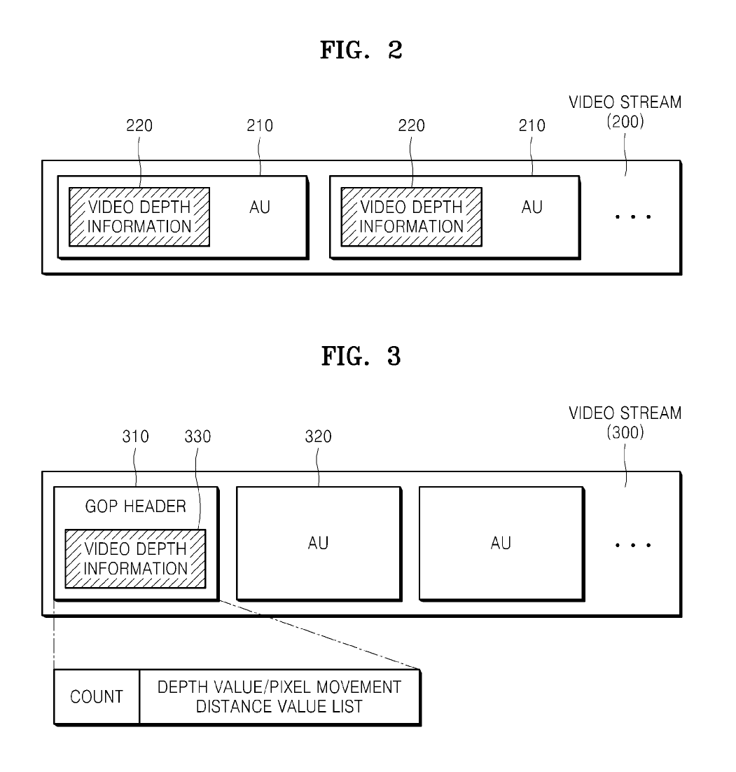

FIG. 2 is a block diagram illustrating an example of a video stream 200. Referring to FIG. 2, the video stream 200 includes one or more access units (AUs) 210. The AUs 210 are a set of network abstraction layer (NAL) units to access information within a bit sequence in a picture unit. That is, an AU corresponds to a coded picture, that is, a picture of a frame, in an encoding/decoding unit.

The video stream 200 includes video depth information 220 for each AU 210. The video depth information 220 is information indicating a depth of a 3-dimensional (3D) video image generated from the video stream 200.

Because a person's eyes are spaced apart from each other by a predetermined distance in a horizontal direction, a 2-dimensional (2D) image viewed by a left eye and a right eye differs. The brain combines the different 2D images to generate a 3D image having perspective and an apparent presence. Thus, in order to reproduce a 2D video image as a 3D image, two different images, one viewed by the left eye (a left eye image) and another by the right eye (a right eye image) with respect to a 2D image, are generated from the 2D image, and the left eye image and the right eye image are alternately reproduced.

The left eye image and the right eye image are generated by moving pixels included in the 2D image at a predetermined distance left or right. A distance, by which pixels move to reproduce the left eye image and the right eye image from the 2D image, varies according to a depth of the 3D image to be generated from the 2D image. Such distance may be between a location of a predetermined pixel in the 2D image and a point of the left eye image and the right eye image to which the predetermined pixel is mapped after moving by a predetermined distance. The term “depth information” may be used to indicate a depth of an image. The video depth information may include a depth value or a movement distance value of a pixel corresponding to the depth value.

In one general aspect, the closer to the viewer an image is disposed, the greater a depth value of the image becomes. According to an illustrative example, the depth value may have one of 256 values from 0 to 255. The farther an image is formed inside a screen from the viewer seeing the screen, the smaller the depth value becomes and, thus, the depth value is closer to 0. The closer to the viewer the image protrudes from the screen, the greater the depth value becomes and, thus, the depth value is closer to 255.

The illustrative example may include the video depth information 220 indicating a depth of the 3D video image to be reproduced from each AU 210 included in the video stream 200.

Although not shown in FIG. 2, each AU 210 may include supplemental enhancement information (SEI) that may include user data SEI messages. The video depth information 220 may be included in the SEI message included in each AU 210. This will be described in more detail with reference to FIG. 4.

An image processing apparatus (not shown) may extract the video depth information 220 from each AU 210 of the video stream 200 and may adjust a depth value of a graphic screen, using the extracted video depth information 220.

The graphic screen is generated by decoding a graphic stream. The graphic stream may include one or a combination of a presentation graphic stream or a text subtitle stream to provide a subtitle, an interactive graphic stream to provide a menu formed of buttons or the like to interact with a user, or a graphical overlay displayed by a program element, such as Java.

The image processing apparatus may adjust the depth value of the graphic screen to be synchronized with the AUs 210 from which the video depth information 220 is extracted, using the extracted video depth information 220. For example, the graphic screen may be reproduced with 3D image corresponding to the AUs 210, and the image processing apparatus may adjust the depth value of the reproduced graphic screen after being synchronized with the AUs 210 from which the video depth information 220 is extracted, using the extracted video depth information 220. The image processing apparatus may adjust the depth value of the graphic screen to be equal to or greater than a depth value of the 3D video image using the depth value included in the video depth information 220 or the movement distance value of the pixel corresponding to the depth value. In this case, the graphic screen protrudes more than the 3D video image and, thus, is output at a location closer to the viewer.

One frame or picture may include one object or a plurality of objects. In this case, the video depth information 220 may include depth information regarding one or all of the plurality of objects or two or more thereof. The image processing apparatus may adjust the depth value of the graphic screen using the depth information regarding one object among the depth information of the objects included in the video depth information 220.

If the depth information of the objects included in the video depth information 220 includes depth values of the objects, the image processing apparatus may adjust the depth value of the graphic screen to be greater than the greatest depth value of one of the objects.

If the video depth information 220 includes a movement distance value of a pixel of each object instead of the depth values of the objects, the image processing apparatus may obtain a depth value corresponding to the movement distance value of the pixel. The image processing apparatus may also identify one of the objects having the greatest depth value, and adjust the depth value of the graphic screen to be greater than the greatest depth value of the identified object.

As described above, according to an illustrative example, the video depth information 220 to adjust the depth value of the graphic screen reproduced with the video image may be included in each AU 210.

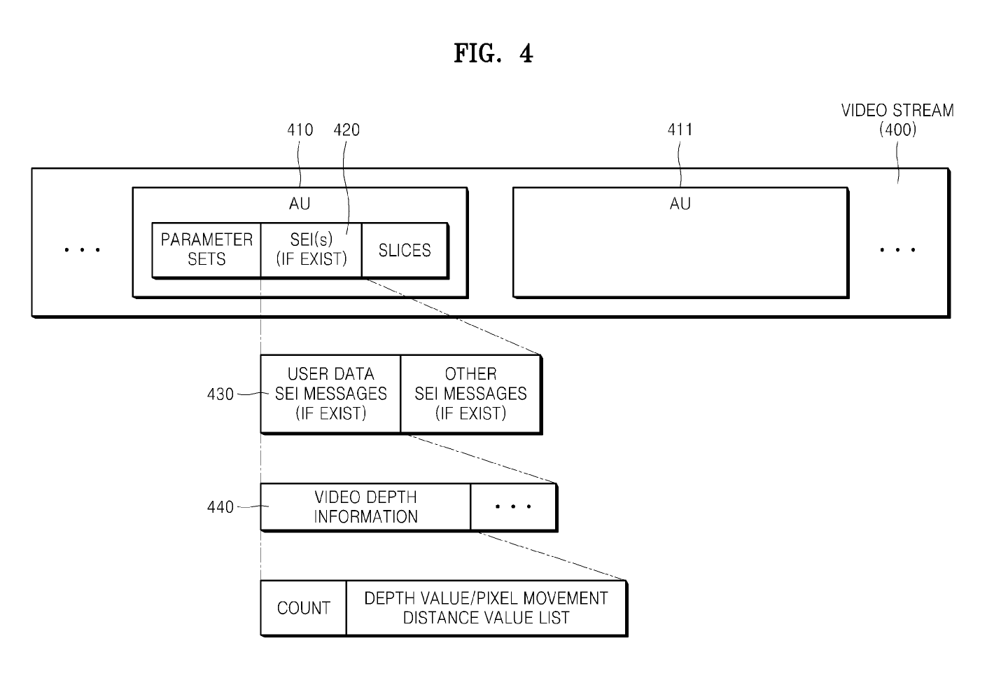

FIG. 3 is a block diagram illustrating an example of a video stream 300. Referring to FIG. 3, the video stream 300 may include one or more group of pictures (GOPs) that includes a set of a series of pictures. The video stream 300 may also include a GOP header 310 for each GOP. The GOP is a bundle of a series of pictures from an I picture to a next I picture, and may further include a P picture and B pictures (not shown). As described above, one picture corresponds to one AU.

In one illustrative aspect, the GOP header 310 may include video depth information 330 of a plurality of AUs included in the GOP, like the video stream 300. As described above, the video depth information 330 includes depth values of a 3D video image or pixel movement distance values corresponding to the depth values of the 3D video image.

The video depth information 330 of the plurality of AUs is included in the GOP header 310, in which a list of a plurality of depth values or a list of a plurality of pixel movement distance values may be included in the video depth information 330. The video depth information 330 may also include as a count value information regarding the number of depth values or the number of pixel movement distance values.

An image processing apparatus (not shown) may extract the video depth information 330 from the GOP header 310, and identify the number of depth values or the number of pixel movement distance values using the count value included in the video depth information 330. The image processing apparatus may group the plurality of AUs included in the GOP into the number included in the video depth information 330, and adjust a depth value of a graphic screen that is reproduced after being synchronized with the AUs included in each group using the depth values or the pixel movement distance values.

As an example, assuming that the GOP includes ten AUs, and the video depth information 330 includes five depth values. The image processing apparatus may group the ten AUs into the five depth values, and adjust the depth value of the graphic screen that is reproduced after being synchronized with the AUs included in each group by sequentially using the five depth values. That is, the image processing apparatus may adjust the depth value of the graphic screen that is reproduced after being synchronized with the AUs included in the first group using a first depth value of the five depth values. The image processing apparatus may also adjust the depth value of the graphic screen that is reproduced after being synchronized with the AUs included in the second group using a second depth value of the five depth values.

If the video depth information 330 includes a list of the movement distance values, instead of the depth values, the image processing apparatus may convert the pixel movement distance values into corresponding depth values, and adjust the depth value of the graphic screen using the converted depth values.

As described above, according to an illustrative example, the video depth information 330 configured to adjust the depth value of the graphic screen reproduced with the AUs included in the GOP may be included in the GOP header 310.

FIG. 4 is a block diagram illustrating an example of a video stream 400. Referring to FIG. 4, the video stream 400 includes one or more GOPs each including a plurality of AUs 410. Video depth information 440 could be included in one of the AUs 410 included in the GOP.

The AUs 410 may include slices that are a set of macro-blocks in which each of macro-blocks may be independently decoded. The AUs 410 may also include parameter sets that are information regarding setting and controlling of a decoder necessary for the slices, and SEI 420 including time information and additional information relating to screen presentation of decoded data. The SEI 420 is used in an application layer that utilizes a generally decoded image and is not included in all AUs 410.

The SEI 420 may include user data SEI messages 430 relating to additional information regarding a subtitle or a menu. According to an illustrative example, the SEI messages 430 may include the video depth information 440.

The video depth information 440 may include depth values of a 3D video image or pixel movement distance values corresponding to the depth values of the 3D video image. The video depth information 440 of the plurality of AUs may be included in one of the AUs 410 so that a list of a plurality of depth values or a list of a plurality of pixel movement distance values may be included in the video depth information 440. Information regarding the number of depth values or the number of pixel movement distance values may also be included as a count value in the video depth information 440.

An image processing apparatus (not shown) may extract the video depth information 440 from the SEI 420 of one of the AUs 410, and identify the number of depth values or the number of pixel movement distance values using the count value in the video depth information 440. The image processing apparatus may group the plurality of AUs 410 in one GOP into the number of depth values or the number of pixel movement distance values in the video depth information 440, and adjust a depth value of a graphic screen that is reproduced after being synchronized with the AUs in each group by sequentially using the depth values.

If the video depth information 440 includes a list of the movement distance values, instead of the depth values, the image processing apparatus may convert the pixel movement distance values into corresponding depth values, and adjust the depth value of the graphic screen using the converted depth values.

As described above, according to an illustrative example, the video depth information 440 configured to adjust the depth value of the graphic screen reproduced with the video image may be included in one of the AUs 410.

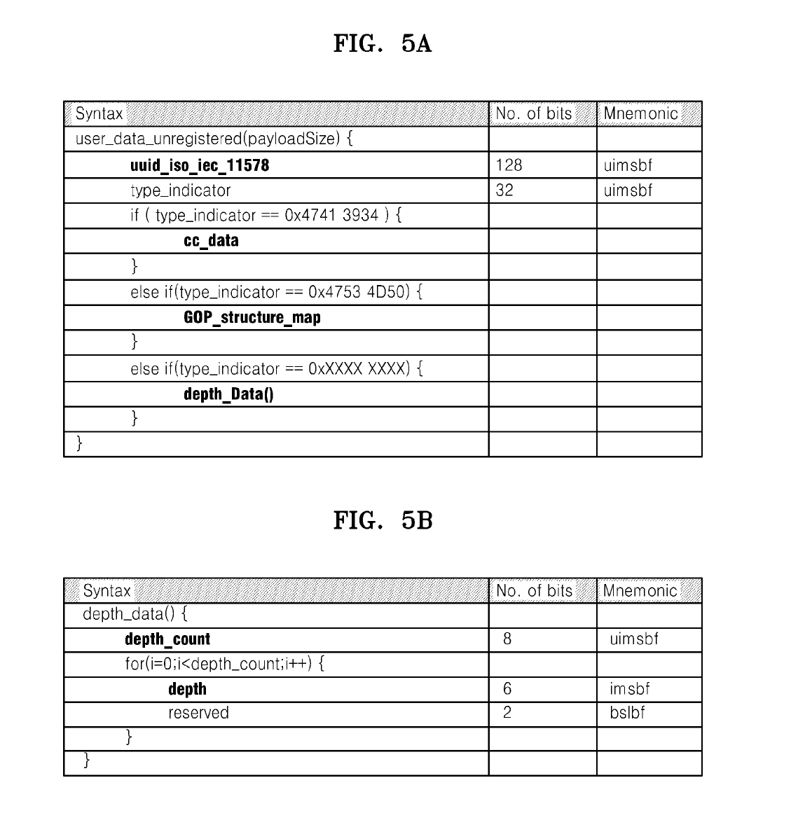

FIGS. 5A and 5B are tables illustrating an example of a syntax presenting video depth information included in a SEI message. Referring to FIG. 5A, a type indicator type_indicator included in the syntax indicates information included after the type indicator. If the type indicator type_indicator has a predetermined value in a third if clause, video depth information depth Data( ) follows the type indicator according to an illustrative example.

Referring to FIG. 5B, the syntax presents the video depth information depth Data( ) The video depth information depth Data( ) includes depth values or pixel movement distance values. The syntax presents a count value depth_count indicating the number of depth values or the number of pixel movement distance values, and presents depth as video depth values or pixel movement distance values as much as the count value depth_count. Where the count value depth_count increases one at a time, that is, where a plurality of AUs are grouped into the count value depth_count, the syntax presents video depth values or pixel movement distance values are sequentially used, one at a time, for example, from a first group, to adjust a depth value of a graphic screen that is reproduced after being synchronized with the AUs included in each group.

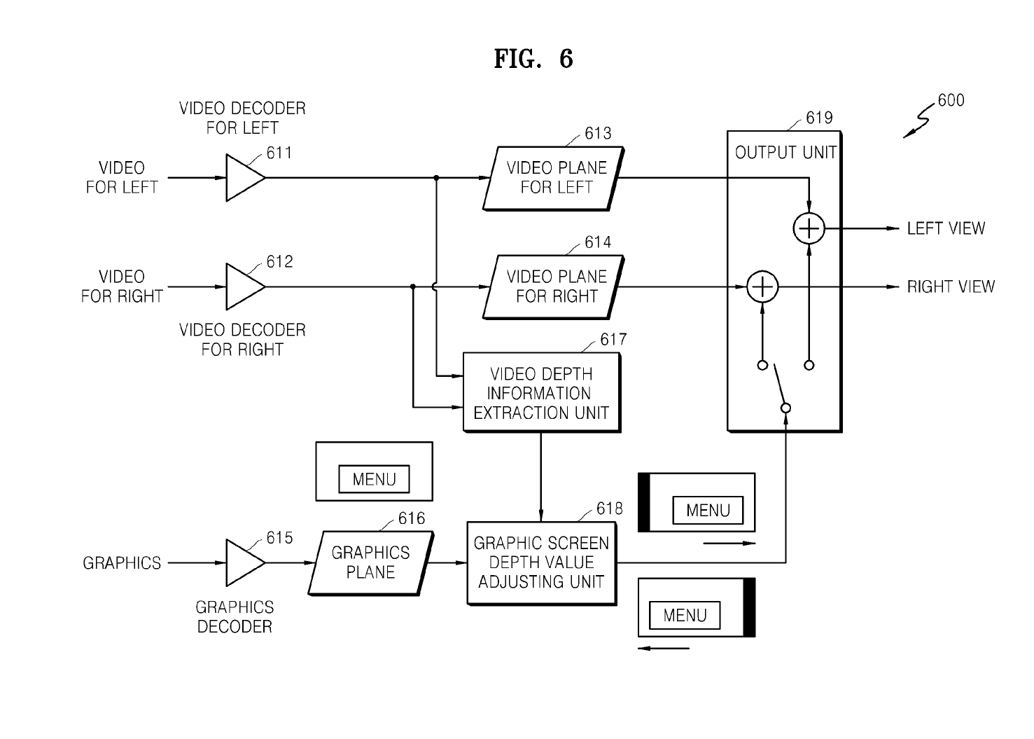

FIG. 6 is a block diagram illustrating an example of an image processing apparatus 600. Referring to FIG. 6, the image processing apparatus 600 includes a left eye video decoder 611, a right eye video decoder 612, a left eye video plane 613, a right eye video plane 614, a graphic decoder 615, a graphic plane 616, a video depth information extraction unit 617, a graphic screen depth value adjusting unit 618, and an output unit 619.

The left eye video decoder 611 may decode a left eye video stream, and may transmit the decoded right eye video stream to the left eye video plane 613. The left eye video plane 613 may generate a left eye image using the decoded left eye video stream. The right eye video decoder 612 may decode a right eye video stream, and may transmit the decoded right eye video stream to the right eye video plane 614. The right eye video plane 614 may generate a right eye image using the decoded right eye video stream.

The left eye video plane 613 and the right eye video plane 614 may temporarily store the left eye image and the right eye image generated by the left eye video decoder 611 and the right eye video decoder 612, respectively.

The video depth information extraction unit 617 extracts video depth information from a video stream, that is, the decoded left eye video stream or the decoded right eye video stream including the video depth information.

The video depth information may be included in the video stream in various forms. For example, the video depth information may be included in each of a plurality of AUs included in the video stream, or video depth information regarding all AUs included in a GOP of the video stream may be included in one of the AUs. Alternatively, video depth information regarding the AUs included in the GOP of the video stream may be included in a header of the GOP. The video depth information may be included in user data SEI messages of SEI included in AUs.

The video depth information extraction unit 617 sends the video depth information extracted from the video stream to the graphic screen depth value adjusting unit 618.

The graphic decoder 615 decodes a graphic stream and transmits that decoded graphics stream to the graphic plane 616. The graphic plane 616 generates a graphic screen. The graphic plane 616 temporarily stores the graphic screen generated.

The graphic screen depth value adjusting unit 618 may adjust a depth value of the graphic screen to be equal to a depth value of a 3D video image, which is reproduced after being synchronized with the graphic screen, using the video depth information received from the video depth information extraction unit 617. In the alternative, the graphic screen depth value adjusting unit 618 may adjust a depth value of the graphic screen to be greater than the depth value of the 3D video image by as much as a predetermined depth value using the video depth information received from the video depth information extraction unit 617.

If the video depth information includes depth information regarding two or more of a plurality of objects included in a video image, which is reproduced after being synchronized with the graphic screen, the graphic screen depth value adjusting unit 618 may adjust the depth value of the graphic screen using a depth value or a pixel movement distance value of an object having the greatest depth value or the greatest pixel movement distance value among the two or more objects included in the video depth information.

In one example, the AUs may be divided into groups by a count value included in the video depth information. In this instance, the video depth information includes depth information regarding a plurality of frames other than one frame, that is, a plurality of AUs, the graphic screen depth value adjusting unit 618 may adjust the depth value of the graphic screen that is reproduced after being synchronized with the AU of each group to one of depth values included in the video depth information or one of pixel movement distance values corresponding to the depth values.

The graphic screen depth value adjusting unit 618 may generate a left eye graphic screen to be output with the left eye image and a right eye graphic screen to be output with the right eye image from the graphic screen generated in the graphic plane 616, using the depth values or the pixel movement distance values in the video depth information. The graphic screen depth value adjusting unit 618 may generate the left eye graphic screen and the right eye graphic screen by moving the whole graphic screen drawn in the graphic plane 616 left or right by the pixel movement distance values included in the video depth information or by a greater value than the pixel movement distance values. If the video depth information includes the depth values, the graphic screen depth value adjusting unit 618 may generate the left eye graphic screen and the right eye graphic screen by moving the whole graphic screen left or right by a predetermined distance in such a way that the graphic screen has a depth value equal to or greater than the depth values included in the video depth information.

In one example, the output unit 619 may simultaneously reproduce the left eye image generated in the left eye video plane 613 and the left eye graphic screen, and may simultaneously reproduce the right eye image generated in the right eye video plane 614 and the right eye graphic screen. The output unit 619 would alternately output the left eye image and the right eye image including the graphic screen and reproduce the 3D video image. In this regard, the graphic screen would have a greater depth value than the video image, so as to reproduce the video image and the graphic screen naturally.

The left eye video decoder 611, the right eye video decoder 612, the left eye video plane 613, the right eye video plane 614, the graphic decoder 615, the graphic plane 616, the video depth information extraction unit 617, the graphic screen depth value adjusting unit 618, and the output unit 619 described in FIG. 6 may be implemented using hardware and software components, for example, processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

Furthermore, the left eye video decoder 611, the right eye video decoder 612, the left eye video plane 613, the right eye video plane 614, the graphic decoder 615, the graphic plane 616, the video depth information extraction unit 617, the graphic screen depth value adjusting unit 618, and the output unit 619 described in FIG. 6 may be implemented as individual structural components or one or more integrated structural components.

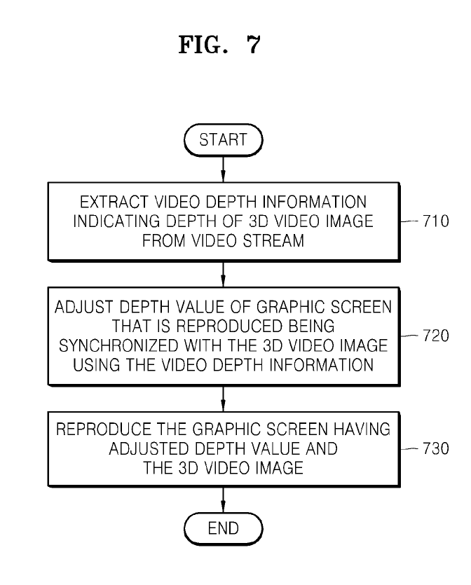

FIG. 7 is a flowchart illustrating an example an image processing method. Referring to FIG. 7, the image processing apparatus 600 of FIG. 6 extracts video depth information indicating a depth of a 3D video image from a video stream (operation 710). The image processing apparatus 600 may extract the video depth information from each of a plurality of AUs included in the video stream or extract the video depth information of the AUs from one of the AUs. Alternatively, the image processing apparatus 600 may extract the video depth information of the AUs included in a GOP from a header of the GOP.

In one aspect, an image processing apparatus includes a video decoder configured to decode a video stream and generating a left eye image and a right eye image. The image processing apparatus also includes a graphic decoder configured to decode a graphic stream and generating a graphic screen. The apparatus also includes a video depth information extraction unit configured to extract video depth information from the video stream. The apparatus further includes a graphic screen depth value adjusting unit configured to adjust a depth value of the graphic screen that is reproduced after being synchronized with the 3D video image using the video depth information, and configured to generate a left eye graphic screen and a right eye graphic screen from the graphic screen. The image processing apparatus also includes an output unit configured to simultaneously reproduce the left eye image and the left eye graphic screen, and configured to simultaneously reproduce the right eye image and the right eye graphic screen, and configured to alternately output the left eye image and the right eye image including the graphic screen and reproduce the 3D video image. The video depth information may include depth values of the 3D video image or pixel movement distance values corresponding to the depth values of the 3D video image.

The image processing apparatus 600 adjusts a depth value of a graphic screen, being synchronized with the 3D video image, using the video depth information (operation 720). The image processing apparatus 600 may adjust the depth value of the graphic screen to be equal to or greater than the depth values of the 3D video image.

In one example, if the video depth information includes depth information regarding two or more of a plurality of objects included in a video image that is reproduced after being synchronized with the graphic screen, the image processing apparatus 600 may adjust the depth value of the graphic screen. The image processing apparatus 600 may adjust the depth value of the graphic screen using a depth value or a pixel movement distance value of an object having the greatest depth value or the greatest pixel movement distance value among the two or more objects included in the video depth information.

In another example, the AUs are divided into groups using a count value included in the video depth information. In this instance, if the video depth information includes depth information of a plurality of AUs, the image processing apparatus 600 may adjust the depth value of the graphic screen that is reproduced after being synchronized with the AU of each group to one of depth values included in the video depth information or one of pixel movement distance values corresponding to the depth values.

The image processing apparatus 600 may reproduce the graphic screen having the adjusted depth value and the 3D video image (operation 730).

It is to be understood that in the embodiment of the present invention, the operations in FIG. 7 are performed in the sequence and manner as shown although the order of some steps and the like may be changed without departing from the spirit and scope of the present invention. In accordance with an illustrative example, a computer program embodied on a non-transitory computer-readable medium may also be provided, encoding instructions to perform at least the method described in FIG. 7.

Program instructions to perform a method described in FIG. 7, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein may be easily construed by programmers skilled in the art to which the embodiments pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An image processing method, comprising:
extracting video depth information indicating a depth of a 3D video image from a video stream; and
adjusting a depth value of a graphic screen, to be synchronized with the 3D video image, using the video depth information.

2. The image processing method of claim 1, wherein the video depth information comprises depth values of the 3D video image or pixel movement distance values corresponding to the depth values of the 3D video image,
wherein the depth values increase from an inside of a screen to an outside of the screen on which a video image is output, and
wherein the adjusting of the depth value of the graphic screen comprises: adjusting the depth value of the graphic screen to be equal to or greater than the depth values of the 3D video image.

3. The image processing method of claim 2, wherein, where the 3D video image comprises a plurality of objects, and the video depth information comprises depth information regarding two or more of the plurality of objects, the adjusting of the depth value of the graphic screen comprises adjusting the depth value of the graphic screen to be equal to or greater than a depth value of an object having a greatest depth value among the two or more objects.

4. The image processing method of claim 2, wherein the video stream comprises a plurality of access units that are decoding units,
wherein the extracting of the video depth information comprises extracting the video depth information from each of the plurality of access units.

5. The image processing method of claim 4, wherein the adjusting of the depth value of the graphic screen comprises: adjusting the depth value of the graphic screen, to be synchronized with the plurality of access units from which the video depth information is extracted, using the extracted video depth information.

6. The image processing method of claim 4, wherein the extracting of the video depth information comprises extracting the video depth information from user data supplemental enhancement information (SEI) messages included in the SEI of the plurality of access units.

7. The image processing method of claim 2, wherein the video stream comprises one or more groups of pictures (GOPs) including a plurality of access units that are decoding units,
wherein the extracting of the video depth information comprises extracting the video depth information from one of the plurality of access units included in the one or more GOPs.

8. The image processing method of claim 7, wherein the extracting of the video depth information comprises extracting the video depth information from user data supplemental enhancement information (SEI) messages included in the SEI of one of the plurality of access units.

9. The image processing method of claim 8, wherein the video depth information comprises a number of the depth values of the 3D video image or a number of the corresponding pixel movement distance values,
wherein the adjusting of the depth value of the graphic screen comprises where the plurality of access units included in the one or more GOPs are divided into groups by the number included in the video depth information, adjusting the depth value of the graphic screen, to be synchronized with the plurality of access units included in each group, using one of the depth values of the 3D video image included in the video depth information or one of the corresponding pixel movement distance values.

10. The image processing method of claim 2, wherein the video stream comprises one or more groups of pictures (GOPs) including a plurality of access units that are decoding units,
wherein the extracting of the video depth information comprises extracting the video depth information from a header of the one or more GOPs.

11. The image processing method of claim 10, wherein the video depth information comprises a number of the depth values of the 3D video image or a number of the corresponding pixel movement distance values,
wherein the adjusting of the depth value of the graphic screen comprises: where the plurality of access units included in the one or more GOPs are divided into groups by the number included in the video depth information, adjusting the depth value of the graphic screen, to be synchronized with the plurality of access units included in each group, using one of the depth values of the 3D video image included in the video depth information or one of the corresponding pixel movement distance values.

12. An image processing apparatus, comprising:
a video decoder configured to decode a video stream and generate a left eye image and a right eye image;
a graphic decoder configured to decode a graphic stream and generate a graphic screen;
a video depth information extraction unit configured to extract video depth information indicating a depth of a 3D video image from the video stream; and
a graphic screen depth value adjusting unit configured to adjust a depth value of the graphic screen to be synchronized with the 3D video image, using the video depth information.

13. The image processing apparatus of claim 12, wherein the video depth information comprises depth values of the 3D video image or pixel movement distance values corresponding to the depth values of the 3D video image,
wherein the depth values increase from an inside of a screen to an outside of the screen on which a video image is output, and
wherein the graphic screen depth value adjusting unit adjusts the depth value of the graphic screen to be equal to or greater than the depth values of the 3D video image.

14. The image processing apparatus of claim 13, wherein, where the 3D video image comprises a plurality of objects, and the video depth information comprises depth information regarding two or more of the plurality of objects, the graphic screen depth value adjusting unit adjusts the depth value of the graphic screen to be equal to or greater than a depth value of an object having a greatest depth value among the two or more objects.

15. The image processing apparatus of claim 13, wherein the video stream comprises a plurality of access units that are decoding units,
wherein the video depth information extraction unit extracts the video depth information from each of the plurality of access units.

16. The image processing apparatus of claim 15, wherein the video depth information extraction unit adjusts the depth value of the graphic screen, to be synchronized with the plurality of access units from which the video depth information is extracted, using the extracted video depth information.

17. The image processing method of claim 15, wherein the video depth information extraction unit extracts the video depth information from user data supplemental enhancement information (SEI) messages included in the SEI of the plurality of access units.

18. The image processing apparatus of claim 13, wherein the video stream comprises one or more groups of pictures (GOPs) including a plurality of access units that are decoding units,
wherein the video depth information extraction unit extracts the video depth information from one of the plurality of access units included in the one or more GOPs.

19. The image processing apparatus of claim 18, wherein the video depth information extraction unit extracts the video depth information from user data supplemental enhancement information (SEI) messages included in the SEI of one of the plurality of access units.

20. The image processing apparatus of claim 19, wherein the video depth information comprises a number of the depth values of the 3D video image or a number of the corresponding pixel movement distance values,
wherein the graphic screen depth value adjusting unit, where the plurality of access units included in the one or more GOPs are divided into groups by the number included in the video depth information, adjusts the depth value of the graphic screen, to be synchronized with the plurality of access units included in each group, using one of the depth values of the 3D video image included in the video depth information or one of the corresponding pixel movement distance values.

21. The image processing apparatus of claim 13, wherein the video stream comprises one or more groups of pictures (GOPs) including a plurality of access units that are decoding units,
wherein the video depth information extraction unit extracts the video depth information from a header of the one or more GOPs.

22. The image processing apparatus of claim 21, wherein the video depth information comprises a number of the depth values of the 3D video image or a number of the corresponding pixel movement distance values,
wherein the graphic screen depth value adjusting unit, where the plurality of access units included in the one or more GOPs are divided into groups by the number included in the video depth information, adjusts the depth value of the graphic screen, to be synchronized with the plurality of access units included in each group, using one of the depth values of the 3D video image included in the video depth information or one of the corresponding pixel movement distance values.

23. A non-transitory computer readable recording medium having recorded thereon a program to execute an image processing method, the image processing method comprising:
extracting video depth information indicating a depth of a 3D video image from a video stream; and
adjusting a depth value of a graphic screen, to be synchronized with the 3D video image, using the video depth information.

24. An image processing apparatus, comprising:
a video decoder configured to decode a video stream and generating a left eye image and a right eye image;
a graphic decoder configured to decode a graphic stream and generating a graphic screen;
a video depth information extraction unit configured to extract video depth information from the video stream;
a graphic screen depth value adjusting unit configured to adjust a depth value of the graphic screen to be synchronized with the 3D video image using the video depth information, and configured to generate a left eye graphic screen and a right eye graphic screen from the graphic screen; and
an output unit configured to simultaneously reproduce the left eye image and the left eye graphic screen, and configured to simultaneously reproduce the right eye image and the right eye graphic screen, and configured to alternately output the left eye image and the right eye image including the graphic screen and reproduce the 3D video image.

25. The image processing apparatus of claim 24, wherein, where the video depth information includes the depth values, the graphic screen depth value adjusting unit is configured to generate the left eye graphic screen and the right eye graphic screen by moving an entire graphic screen left or right by a predetermined distance so that the graphic screen has a depth value equal to or greater than the depth values included in the video depth information.
